(19) United States
(12) Patent Application Publication
(10) Pub. No.: US 2025/0053459 A1
(43) Pub. Date: Feb. 13, 2025

(54) API CALL ROUTING WITHIN HYBRID-CLOUD ARCHITECTURE SYSTEMS

(71) Applicant: Truist Bank, Charlotte, NC (US)

(72) Inventors: Jason Pedone, Raleigh, NC (US); Amy Kaufman Humphries, Stanford, IL (US); Randy Eric Borth, Concord, NC (US)

(73) Assignee: Truist Bank, Charlotte, NC (US)

(21) Appl. No.: 18/447,829

(22) Filed: Aug. 10, 2023

(51) Int. Cl. G06F 9/50; G06F 9/54

(52) U.S. Cl. CPC G06F 9/505; G06F 9/5072; G06F 9/541

(57) ABSTRACT

Systems and methods transfer a replica of data from data provider(s), where the data provider(s) include either public-cloud resource(s) or private on-premise resource(s). The transferring includes extracting data from data provider(s) to a temporary location, transforming the extracted data into a format suitable for loading the data to a cloud operational data store, and loading the transformed data to the cloud operational data store. Further, data enrichment process(es) are performed to the replica of the data loaded to the cloud operational data store. Data access is provided, within the hybrid-cloud infrastructure environment, by routing an API call to access the data from a location selected from the group consisting of (i) the replica of the data loaded to the cloud operational data store, (ii) the on-premise resource(s), and (iii) the public-cloud resource(s).

### FIELD OF THE INVENTION

This invention relates generally to the field of data process management, and more particularly embodiments of the invention relate to data process management systems and methods that utilize a hybrid-cloud infrastructure environment.

### BACKGROUND OF THE INVENTION

A hybrid cloud architecture incorporates a combination of on-premise private cloud and a public cloud provider's infrastructure-as-a-service (IaaS) virtualized computing resources. Hybrid cloud architecture can be used to enhance scalability and provide data management. However, a hybrid cloud infrastructure can introduce additional complexities, which can cause cloud service latency. Hybrid cloud environments that take more time for data to become available are less user friendly and can cause a negative experience for customer facing businesses. Hybrid cloud environments can also encounter difficulties when certain service providers are down and the data is unavailable.

Thus, a need exists for improved systems and methods for resilient data access within a hybrid cloud environment.

### BRIEF SUMMARY

Shortcomings of the prior art are overcome and additional advantages are provided through the provision of a hybrid-cloud infrastructure environment for application programming interface (API) call routing. The hybrid-cloud infrastructure environment includes at least one public-cloud resource, at least one private on-premise resource, and a computer system that includes at least one processor, a communication interface communicatively coupled to the at least one processor, and a memory device storing executable code that when executed causes the at least one processor to transfer a replica of data from at least one data provider, where the at least one data provider includes either the at least one public-cloud resource or the at least one private on-premise resource. The transferring includes extracting data from the at least one data provider to a temporary location, transforming the extracted data into a format suitable for loading the data to a cloud operational data store, and loading the transformed data to the cloud operational data store. One or more data enrichment processes are performed to the replica of the data loaded to the cloud operational data store, and data access is provided within the hybrid-cloud infrastructure environment by routing an API call to access the data from a location selected from the group consisting of (i) the replica of the data loaded to the cloud operational data store (ii) the at least one on-premise resource, and (iii) the at least one public-cloud resource.

Additionally, disclosed herein is a computing system for data process management, where the computing system includes at least one processor, a communication interface communicatively coupled to the at least one processor, and a memory device storing executable code that, when executed, causes the at least one processor to transfer a replica of data from at least one data provider, where the at least one data provider includes either at least one public-cloud resource or at least one private on-premise resource. The transferring includes extracting data from the on-premise resource to a temporary location, transforming the extracted data into a format suitable for loading the data to the at least one public-cloud resource, and loading the transformed data to the at least one public-cloud resource. One or more data enrichment processes are performed to the replica of the data loaded to the at least one public-cloud resource, and data access is provided, within a hybrid-cloud infrastructure environment, by routing an API call to access the data from a location selected from the group consisting of (i) the replica of the data loaded to the cloud operational data store, (ii) the at least one on-premise resource, and (iii) the at least one public-cloud resource.

Also disclosed herein is a computer-implemented method for data process management, where the computer-implemented method includes transferring a replica of data from at least one data provider, the at least one data providing including either at least one public-cloud resource and at least one private on-premise resource. The transferring includes extracting data from the on-premise resource to a temporary location, transforming the extracted data into a format suitable for loading the data to the at least one public-cloud resource, and loading the transformed data to the at least one public-cloud resource. One or more data enrichment processes are performed to the replica of the data loaded to the at least one public-cloud resource, and data access is provided, within a hybrid-cloud infrastructure environment, by routing an API call to access the data from a location selected from the group consisting of (i) the replica of the data loaded to the cloud operational data store, (ii) the at least one on-premise resource, and (iii) the at least one public-cloud resource.

The features, functions, and advantages that have been described herein may be achieved independently in various embodiments of the present invention including computer-implemented methods, computer program products, and computing systems or may be combined in yet other embodiments, further details of which can be seen with reference to the following description and drawings.

### BRIEF DESCRIPTION

One or more aspects are particularly pointed out and distinctly claimed as examples in the claims at the conclusion of the specification. The foregoing as well as objects, features, and advantages of one or more aspects are apparent from the following detailed description taken in conjunction with the accompanying drawings in which:

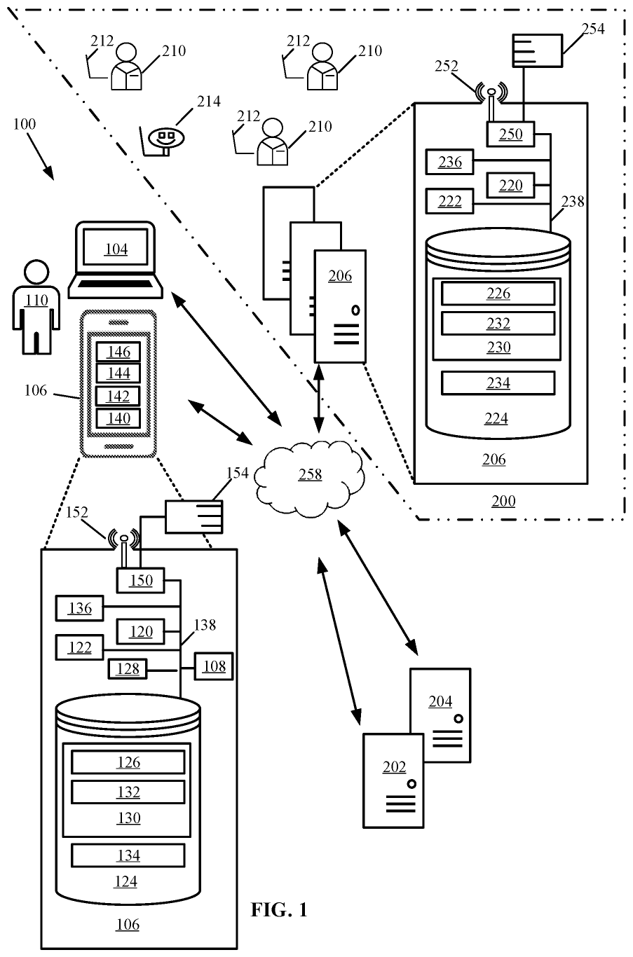

FIG. 1 illustrates a computing environment that includes a hybrid-cloud infrastructure environment, in accordance with an embodiment of the present invention;

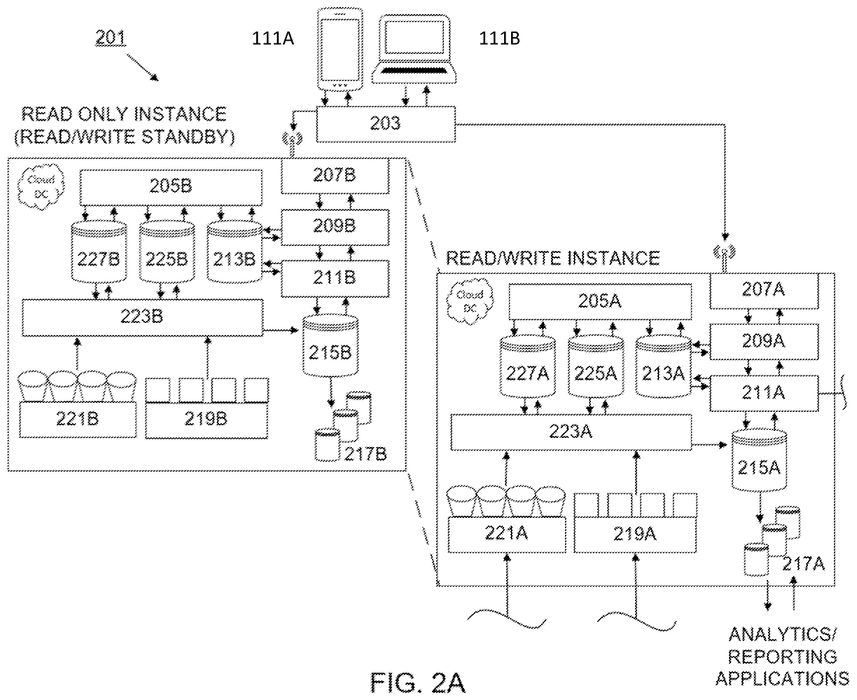

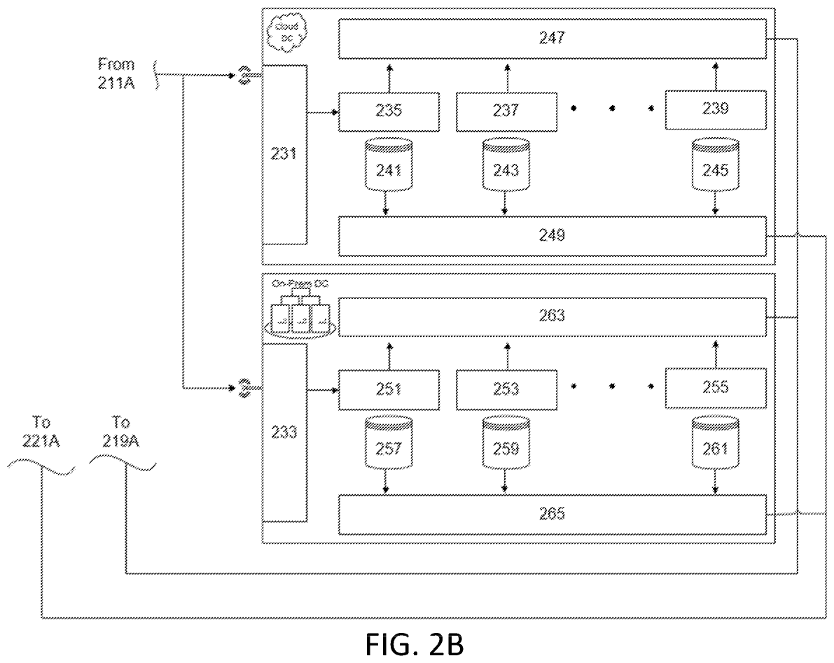

FIG. 2A depicts aspects of an example hybrid-cloud environment facilitating resilient data access, in accordance with an embodiment of the present invention;

FIG. 2B depicts additional aspects of the example hybrid-cloud environment of FIG. 2A, in accordance with an embodiment of the present invention;

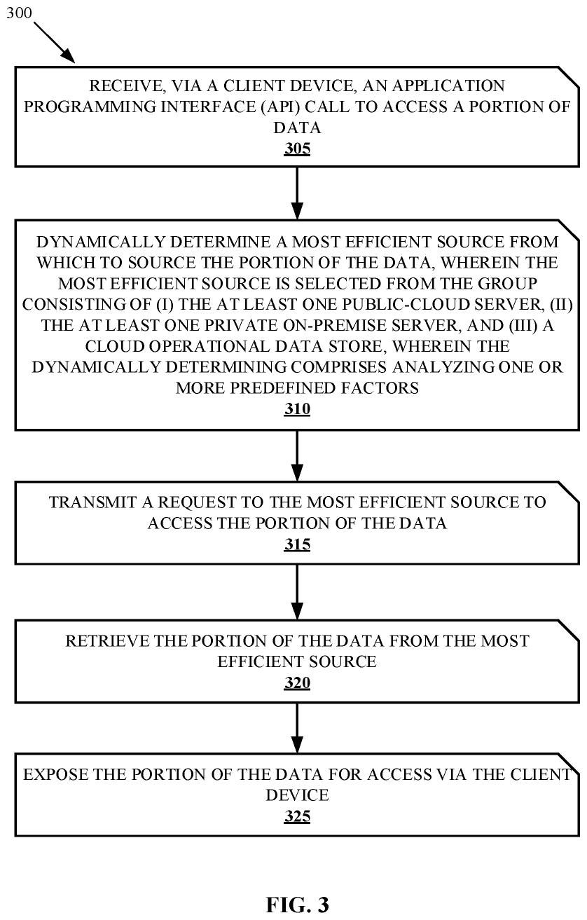

FIG. 3 depicts a block diagram of an example method for resilient data access facilitated by a hybrid-cloud infrastructure environment, in accordance with an embodiment of the present invention;

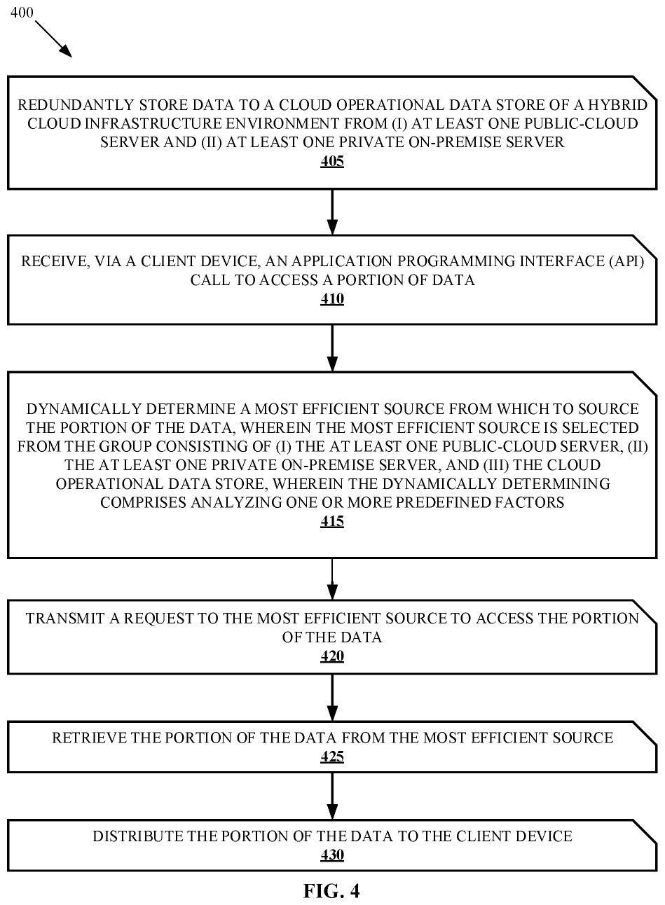

FIG. 4 depicts a block diagram of an example method for resilient data access, in accordance with an embodiment of the present invention; and

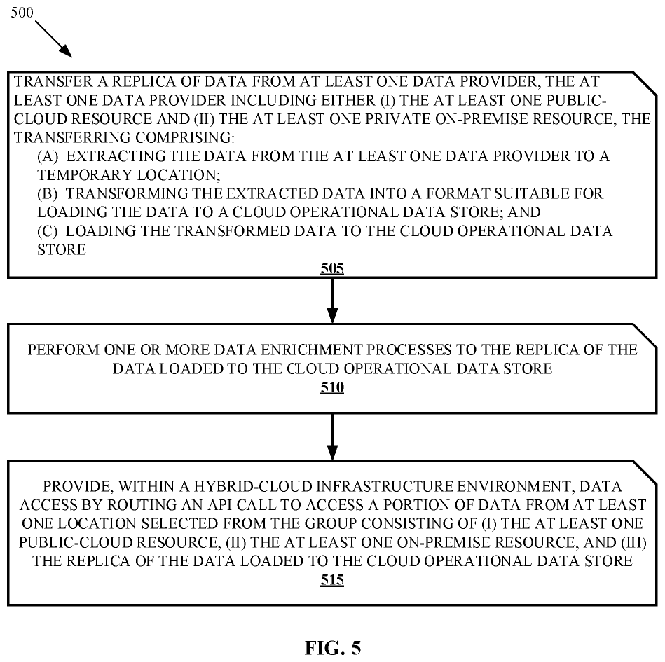

FIG. 5 depicts a block diagram of an example method for application programming interface (API) call routing, in accordance with an embodiment of the present invention.

### DETAILED DESCRIPTION

Aspects of the present invention and certain features, advantages, and details thereof are explained more fully below with reference to the non-limiting examples illustrated in the accompanying drawings. It is to be understood that the disclosed embodiments are merely illustrative of the present invention and the invention may take various forms. Further, the figures are not necessarily drawn to scale, as some features may be exaggerated to show details of particular components. Thus, specific structural and functional details illustrated herein are not to be interpreted as limiting, but merely as a representative basis for teaching one skilled in the art to employ the present invention.

Descriptions of well-known processing techniques, systems, components, etc. are omitted to not unnecessarily obscure the invention in detail. It should be understood that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. Note further that numerous inventive aspects and features are disclosed herein, and unless inconsistent, each disclosed aspect or feature is combinable with any other disclosed aspect or feature as desired for a particular embodiment of the concepts disclosed herein.

The specification may include references to “one embodiment,” “an embodiment,” “various embodiments,” “one or more embodiments,” etc. may indicate that the embodiment(s) described may include a particular feature, structure or characteristic, but every embodiment may not necessarily include the particular feature, structure, or characteristic. In some cases, such phrases are not necessarily referencing the same embodiment. When a particular feature, structure, or characteristic is described in connection with an embodiment, such description can be combined with features, structures, or characteristics described in connection with other embodiments, regardless of whether such combinations are explicitly described. Thus, unless described or implied as exclusive alternatives, features throughout the drawings and descriptions should be taken as cumulative, such that features expressly associated with some particular embodiments can be combined with other embodiments.

The terminology used herein is for the purpose of describing particular embodiments only and is not intended to be limiting of the invention. As used herein, the singular forms “a.” “an.” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method, step of a method, device or element of a device that “comprises,” “has,” “includes,” or “contains,” or uses similar language to describe one or more steps or elements possesses those one or more steps or elements, but is not limited to possessing only those one or more steps or elements. Furthermore, a device or structure that is configured in a certain way is configured in at least that way, but may also be configured in ways that are not listed.

Like numbers refer to like elements throughout. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “couple,” “coupled,” “connected,” and the like should be broadly understood to refer to connecting two or more elements or signals electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant. “Communicatively coupled to” and “operatively coupled to” can refer to physically and/or electrically related components.

In addition, as used herein, the terms “about,” “approximately,” or “substantially” for any numerical values or ranges indicate a suitable dimensional tolerance that allows the device, part, or collection of components to function for its intended purpose as described herein.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code can include both software and hardware. For example, program code in certain embodiments of the present invention can include fixed function hardware, while other embodiments can utilize a software-based implementation of the functionality described. Certain embodiments combine both types of program code.

As used herein, the terms “enterprise” or “provider” generally describes a person or business enterprise (e.g., company, organization, institution, business, university, etc.) that hosts, maintains, or uses computer systems that provide functionality for the disclosed systems and methods. In particular, the term “enterprise” may generally describe a person or business enterprise providing goods and/or services. Interactions between an enterprise system and a user device can be implemented as an interaction between a computing system of the enterprise and a user device of a user. For instance, user(s) may provide various inputs that can be interpreted and analyzed using processing systems of the user device and/or processing systems of the enterprise system. Further the enterprise computing system and the user device may be in communication via a network. According to various embodiments, the enterprise system and/or user device(s) may also be in communication with an external or third-party server of a third party system that may be used to perform one or more server operations. In some embodiments, the functions of one illustrated system or server may be provided by multiple systems, servers, or computing devices, including those physically located at a central computer processing facility and/or those physically located at remote locations.

Embodiments of the present invention are described herein with reference to flowchart illustrations and/or block diagrams of computer-implemented method(s) and computing system(s). Each block or combinations of blocks of the flowchart illustrations and/or block diagrams can be implemented by computer readable program instructions or code that may be provided to a processor of a general purpose computer, special purpose computer, programmable data processing apparatus or apparatuses (the term “apparatus” includes systems and computer program products), and/or other device(s). In particular, the computer readable program instructions, which can be executed via the processor of the computer, programmable data processing apparatus, and/or other device(s), create a means for implementing the functions/acts specified in the flowchart and/or block diagram block(s).

In one embodiment, computer readable program instructions may also be stored in one or more computer-readable storage media that can direct a computer, programmable data processing apparatus, and/or other device(s) to function in a particular manner such that a computer readable storage medium of the one or more computer-readable storage media having instructions stored therein comprises an article of manufacture that includes the computer readable program instructions, which implement aspects of the actions specified in the flowchart illustrations and/or block diagrams. In particular, the computer-readable program instructions may be used to produce a computer-implemented method by executing the instructions to implement the actions specified in the flowchart illustrations and/or block diagram block(s). Additionally or alternatively, these computer program instructions may be stored in a computer-readable memory that can direct a computer, programmable data processing apparatus, and/or other device(s) to function in a particular manner such that the instructions stored in the computer readable memory produce an article of manufacture that includes the computer readable program instructions, which implement the function/act specified in the flowchart and/or block diagram block(s). In some embodiments, computer-implemented steps/acts may be performed in combination with operator/human implemented steps/acts in order to carry out an embodiment of the invention.

In the flowchart illustrations and/or block diagrams disclosed herein, each block in the flowchart/diagrams may represent a module, segment, a specific instruction/function or portion of instructions/functions, and incorporates one or more executable computer readable program instructions for implementing the specified logical function(s). Similarly, alternative implementations and processes may also incorporate various blocks of the flowcharts and block diagrams. For instance, in some implementations the functions noted in the blocks may occur out of the order noted in the figures. For example, two blocks shown in succession may be executed substantially concurrently, and/or the functions of the blocks may sometimes be executed in the reverse order, depending upon the functionality involved.

FIG. 1 illustrates a computing environment 100 that includes a hybrid cloud infrastructure environment, according to at least one embodiment of the present invention. The computing environment 100 generally includes a user 110 (e.g., customer of the enterprise) that benefits through use of services and products offered by an enterprise system 200. Use of the words “service(s)” or “product(s)” as used herein can be interchangeable. The user 110 can be an individual, a group, or any entity in possession of or having access to the user device 104, 106, which may be personal, enterprise, or public items. Although the user 110 may be singly represented in some figures, in at least in some embodiments the user 110 is one of many such that a market or community of users, consumers, customers, business entities, government entities, clubs, and groups of any size.

The computing environment 100 may include, for example, a distributed cloud computing environment (private cloud, public cloud, community cloud, and/or hybrid cloud), an on-premise environment, fog-computing environment, and/or an edge-computing environment. The user 110 accesses services and products of the enterprise system 200 by use of one or more user devices, illustrated in separate examples as user devices 104, 106. Example user devices 104, 106 may include a laptop, desktop computer, tablet, a mobile computing device such as a smart phone, a portable digital assistant (PDA), a pager, a mobile television, a gaming device, an audio/video player, a virtual assistant device or other smart home device, a wireless personal response device, or any combination of the aforementioned, or other portable device with processing and communication capabilities.

In the illustrated example, the mobile device 106 is illustrated in FIG. 1 as having exemplary elements, the below descriptions of which apply as well to the computing device 104. The user device 104, 106 can include integrated software applications that manage device resources, generate user interfaces, accept user inputs, and facilitate communications with other devices among other functions. The integrated software applications can include an operating system, such as Linux®, UNIX®, Windows®, macOS®, iOS®, Android®, or other operating system compatible with personal computing devices. Furthermore, the user device 104, 106 may be and/or include a workstation, a server, a set of servers, a cloud-based application or system, or any other suitable system or device adapted to execute any suitable operating system used on personal computers, central computing systems, phones, and/or other devices.

The user device 104, 106, but as illustrated with specific reference to the mobile device 106, includes at least one of each of a processor 120, and a memory device 122 for processing use, such as random access memory (RAM), and read-only memory (ROM), and other various components. The illustrated mobile device 106 further includes a storage device 124 including at least one of a non-transitory storage medium, such as a microdrive, for long-term, intermediate-term, and short-term storage of computer-readable program instructions 126 for execution by the processor 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and/or other data items preferred by the user or otherwise required or related to any or all of the applications or programs 130.

The memory device 122 is operatively coupled to the processor 120. As used herein, memory device 122 includes store any computer readable medium configured to store data, code, and/or other information. The memory device 122 may include volatile memory, such as volatile Random Access Memory (RAM), and/or a cache area for the temporary storage of data. The memory device 122 may also include non-volatile memory and may be embedded and/or may be removable. The non-volatile memory additionally or alternatively can include an electrically erasable programmable read-only memory (EEPROM), flash memory, or the like.

According to various embodiments, the memory device 122 and storage device 124 may be combined into a single storage medium. The memory device 122 and storage device 124 can store any of a number of applications that comprise computer-executable program instructions or code executed by the processing device 120 to implement, via the user device 104, 106, the functions described herein. For example, the memory device 122 may store applications and/or association data related to a conventional web browser application and/or an enterprise-distributed application (e.g., a mobile application). These applications also typically provide a graphical user interface (GUI) that is displayed via the display 140 that allows the user 110 to perform functions via the application including to communicate, via the user device 104, 106 with the enterprise system 200, and/or other devices or systems. The GUI on the display 140 may include features for displaying information and accepting inputs from users, and may include input controls such as fillable text boxes, data fields, hyperlinks, pull down menus, check boxes, and the like.

In various embodiments, the user 110 may download, sign into, or otherwise access the application from an enterprise system 200 or from a distinct application server. In other embodiments, the user 110 interacts with the enterprise system 200 via a web browser application in addition to, or instead of, the downloadable version of the application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 may also include the functionality to encode and interleave messages and data prior to modulation and transmission. The processing device 120 can additionally include an internal data modem to convert data from digital format to a format suitable for analog transmission. Further, the processing device 120 may include functionality to operate one or more software programs, which may be stored in the memory device 122 or in the storage device 124. For example, the processing device 120 may be capable of operating a connectivity program such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information and data that are used by the user device 104, 106 as well as the applications and devices that facilitate functions of the user device 104, 106, or that are in communication with the user device 104, 106, to implement the functions described herein, and other functions not expressly described. For example, the storage device 124 may include user authentication information data as well as other data.

The processing device 120, in various examples, can operatively perform calculations, can process instructions for execution, and can manipulate information. The processing device 120 can execute machine-executable program instructions stored in the storage device 124 and/or memory device 122 to perform the methods and functions as described or implied herein. Specifically, the processing device 120 can execute machine-executable instructions to perform actions as expressly provided in one or more corresponding flow charts and/or block diagrams or as would be impliedly understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data, or may convert digital data to another type of signal. For example, the input/output circuitry may receive and convert physical contact inputs, physical movements, or auditory signals (e.g., which may be used to authenticate a user) to digital data. Once converted, the digital data may be provided to and processed by the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices may include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). The input and output system 136 may also include a camera 146, such as a digital camera.

Non-limiting examples of input devices and/or output devices of the input and output system 136 may include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and the enterprise system 200.

In some embodiments, a credentialed system enabling authentication of a user may be necessary in order to provide access to the enterprise system 200. In one embodiment, the input and output system 136 may be configured to obtain and process various forms of authentication to authenticate a user 110 prior to providing access to the enterprise system 200. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

The user device, referring to either or both of the computing device 104 and the mobile device 106 may also include a positioning device 108, which can be for example a global positioning System (GPS) transceiver configured to be used by a positioning system to determine a location of the computing device 104 or mobile device 106. In some embodiments, the positioning system device 108 includes an antenna, transmitter, and receiver. In one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138 (e.g., system bus), electrically connects the various described, illustrated, and implied components of the mobile device 106. The intraconnect 138, in various non-limiting examples, can include or represent, a system bus, a high-speed interface connecting the processing device 120 to the memory device 122, providing electrical connections among the components of the mobile device 106, and may include electrical conductive traces on a motherboard common to some or all of the above-described components of the user device (referring to either or both of the computing device 104 and the mobile device 106). As discussed herein, the system intraconnect 138 may operatively couple various components with one another, or in other words, electrically connects those components either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide wired (e.g., via wired or docked communication by electrically conductive connector 154) or wireless (e.g., via wireless communication device 152) two-way communications and data exchange. Communications may be conducted via various modes or protocols, of which GSM voice calls, short message service (SMS), enterprise messaging service (EMS), multimedia messaging service (MMS) messaging, TDMA, CDMA, PDC, WCDMA, CDMA2000, and GPRS, are all non-limiting and non-exclusive examples. Wireless communications may be conducted via the wireless communication device 152, which can include, as non-limiting examples, a radio-frequency transceiver, a Bluetooth device, Wi-Fi device, a Near-field communication device, and other transceivers. In addition, GPS connections may be included for ingoing and/or outgoing navigation and location-related data exchanges. Wired communications may be conducted, e.g., via the connector 154, by USB, Ethernet, and/or other physically connected modes of data transfer.

The processing device 120 may, for example, be configured to use the communication interface 150 as a network interface to communicate with one or more other devices on a network. In this regard, the communication interface 150 utilizes the wireless communication device 152 such as an antenna operatively coupled to a transmitter and a receiver (or together a “transceiver”) included with the communication interface 150. The processing device 120 is configured to provide signals to and receive signals from the transmitter and receiver, respectively. In various embodiments, the signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, and/or fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), with fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

The computing environment 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may be utilized. In some implementations, a single system or server may provide the functions of one or more systems, servers, or illustrated components. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging. TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, near-field communication device, and other transceivers. In addition, GPS may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, IOS, Android, and any known other operating system used on personal computer, central computing systems, phones, and other devices.

The user devices, referring to either or both of the computing device 104 and mobile device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

The network 258 may incorporate a cloud platform/data center that support various service models including Platform as a Service (PaaS), Infrastructure-as-a-Service (IaaS), and Software-as-a-Service (SaaS). Such service models may provide, for example, a digital platform accessible to the user device (referring to either or both of the computing device 104 and the mobile device 106). Specifically, SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

Two external systems 202 and 204 are expressly illustrated in FIG. 1, representing any number and variety of data sources, users, consumers, customers, business entities, systems, entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the user device 106 during transactions and also configured to interact with the enterprise system 200 in back-end transactions clearing processes. The enterprise system 200 may communicate with the external system 202, 204 using any combination of public or private communication.

In certain embodiments, one or more of the systems such as the user device (referring to either or both of the computing device 104 and the mobile device 106), the enterprise system 200, and/or the external systems 202 and 204 are, include, or utilize virtual resources. In some cases, such virtual resources are considered cloud resources or virtual machines. The cloud computing configuration may provide an infrastructure that includes a network of interconnected nodes and provides stateless, low coupling, modularity, and semantic interoperability. Such interconnected nodes may incorporate a computer system that includes one or more processors, a memory, and a bus that couples various system components (e.g., the memory) to the processor. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

According to one embodiment, a user 110 may initiate an interaction with the enterprise system 200 via the user device 104, 106 and based thereon the enterprise system 200 may transmit, across a network 258, to the user device 104, 106 digital communication(s). In order to initiate the interaction, the user 110 may select, via display 140, a mobile application icon of a computing platform of the enterprise system 200, login via a website to the computing platform of the enterprise system 200, or perform various other actions using the user device 104, 106 to initiate the interaction with the enterprise system 200. In other embodiments, the enterprise system 200 may initiate the interaction with the user 110 via the user device 104, 106. For instance, periodically the enterprise system 200 may transmit unprompted communication(s) such as a short message service (SMS) text message, multimedia message (MMS), or other messages to the user device 104, 106 that includes an embedded link, a web address (e.g., a uniform resource locator (URL)), a scannable code (e.g., a quick response (QR) code, barcode, etc.) to prompt the user 110 to interact with the enterprise system 200.

Once an interaction has been established between the enterprise system 200 and the user device 104, 106, data and/or other information may be exchanged via data transmission or communication in the form of a digital bit stream or a digitized analog signal that is transmitted across the network 258. Based on the user 110 of the user device 104, 106 providing one or more user inputs (e.g., via the user interface, via a speech signal processing system, etc.) data may be received by the enterprise system 200 and data processing is performed thereon using, for example, processing device 220. In one example embodiment, the enterprise computing system 206 comprises multiple processing devices 220 and/or storage devices 224 housed within the physical location of the enterprise rather than in the cloud or hosted in a remote facility. The received data may then be stored to the storage device(s) 224 or to a third party storage resource such as, for example, external systems 202, 204, which may include a public cloud storage service, a private cloud storage service, and/or remote database(s). Additionally, this collected response data may be aggregated in order to allow the enterprise to have a sampling of responses from multiple users 110. Such aggregated data may be accessible by a relational database management system (e.g., Microsoft SQL server, Oracle Database, MySQL, PostgreSQL, IBM Db2, Microsoft Access, SQLite, MariaDB, Snowflake, Microsoft Azure SQL Database, Apache Hive, Teradata Vantage, etc.) or other software system that enables users to define, create, maintain and control access to information stored by the storage device 224, database, and/or other external systems 202, 204. According to one embodiment, the relational database management system may maintain relational database(s) and may incorporate structured query language (SQL) for querying and updating the database. The relational database(s) may organize data into one or more tables or “relations” of columns (e.g., attributes) and rows (e.g., record), with a unique key identifying each row. According to various embodiments, each table may represent a user/customer profile and the various attributes and/or records may indicate attributes attributed to the user/customer.

For instance, the user/customer profiles may be classified based on various designations/classifiers such as their financial assets, income, bank account types, age, geographic region(s), etc. Each designation/classifier may also include a plurality of sub categories. Storing the collected data to the relational database of the relational database management system may facilitate sorting of the data to filter based on various categories and/or subcategories and/or performing data analytics thereon. According to some embodiments, the enterprise system 200 may utilize algorithms in order to categorize or otherwise classify the data.

The collected data may also have metadata associated therewith that can be accessed by the enterprise system 200. The metadata may include, for example, (i) sequencing data representing the data and time when the response data was created, (ii) modification data indicating the individual (such as user 110) that last modified specific information/data, (iii) weighting data representing the relative importance or magnitude of the attributes, (iv) provider identifier data identifying the owner of the data (e.g., the entity that operates the enterprise system 200), and/or (v) other types of data that could be helpful to the enterprise in order to classify and analyze the collected data.

As described herein, on-premise software is installed locally on the computing system 206 within the enterprise system 200 at a physical location of the enterprise. The on-premise software is installed and runs on the enterprise's own private hardware infrastructure that is hosted locally. Cloud software is stored and managed through use of multiple data center locations that share resources. A hybrid cloud computing environment utilizes third-party public cloud, private cloud on-premise resources that remain distinct entities with orchestration between these platforms. For example, the different platforms may communicate via a WAN or broadband connection to share applications and exchange data.

Data is increasingly important to any modern enterprise and it is important for enterprises to continually provide access to data. Existing processes used to source and access data can be inefficient and is critical for business scalability. Existing processes also create problems when a data provider system goes down as this can impact customer access to data critical for to the customer. Thus, disclosed herein is an efficient means to access data, which is key for client facing applications as well as various use cases of the enterprise such as use cases that are enabled by artificial intelligence. In addition, the disclosed systems and methods provide an efficient method for resiliently sourcing data in a hybrid architecture that includes both cloud-based data and data sourced at on-premise data centers. In particular, the disclosed systems and methods provide a novel data aggregation process through a cloud operational data store that sources data from data providers using both batch and streaming interfaces. The cloud operational data store facilitates resilient data access and improved efficiency.

FIGS. 2A and 2B depict aspects of an example hybrid-cloud environment 201 facilitating resilient data access, in accordance with an embodiment of the present invention. When users utilize client device(s) 111A, 111B to access a website and/or application of an enterprise, an external load balancer 203 routes external traffic by forwarding packets to the appropriate destination. The external load balancer 203 is the single point of contact for the client device(s) 111A, 111B and distributes external traffic based on geographic region and node availability to the appropriate application programming interface (API) layer 207A, 207B. In particular, each geographic region will have identical sets of code and processes where some database instances include a read only instance, which is available for read requests only and acts as a read/write standby, and other database instances include a read/write instance, which is available for read requests from consuming applications and writes from data providers. Typically, both the read only instance and the read/write instance will produce identical outcomes. Situations in which the read only instances are to be used would be determined via the data access engine 209A, 209B. which is the supporting logic behind the API layer 207A, 207B. As depicted in FIG. 2A, the read/write instance includes numbers with “A” appended to the end of the number, whereas the read only instance includes numbers with “B” appended to the end of the number. The hybrid-cloud environment 201 functions as an active-active cluster made up of multiple nodes (i.e., the read/write instance(s) and the read only instance(s)) such that the load balancer 203 provides load balancing by distributing workloads across the nodes to prevent overload of a single node.

The API layer 207A, 207B may include a representational state transfer (REST) API or RESTful API that conforms to the restraints of a REST architectural style acts as an interface or gateway to exchange information securely over the internet. The API layer 207A, 207B is exposed to registered applications and the REST architecture imposes conditions to manage communication so that the client device(s) 111A, 111B formats a request in a way that the enterprise's server would understand. According to various embodiments, the API layer 207A, 207B may include multiple versions of the API to support different client device(s) 111A, 111B and use cases. As modifications are made to existing services or new services are added, the API may need to be modified to accommodate these changes. When multiple versions of the API are created, the API can be modified while simultaneously ensuring that client device(s) 111A, 111B can use the prior version of the API. The API layer 207A. 207B can route a request from the client device(s) 111A, 111B to the appropriate version based on the version number, which allows different versions of the API to coexist. In some implementations, the API layer 207A, 207B can transform requests and responses between different versions of the API to ensure compatibility with client device(s) 111A, 111B. Backwards compatibility is enabled by mapping requests from older versions of an API to newer versions of the API or by translating responses from newer version of the API to older versions of the API. Thus, the API layer 207A, 207B provides flexibility and scalability.

The API layer 207A, 207B also provides security by requiring authentication and imposing limits on the number of API calls that the client device(s) 111A, 111B are able to make over a period of time, which is generally based on a number of requests per second. The API layer 207A, 207B also provides buffering and filtering of incoming requests from client device(s) 111A, 111B prior to forwarding the requests on for processing. The API layer 207A, 207B provides authentication by verifying the client device(s) 111A, 111B using, for example, secret tokens (e.g., API keys, code and password, HTTP headers, JavaScript Object Notation (JSON) web tokens, etc.) sent in the API request such as the request header or request URL.

The data access engine 209A, 209B facilitates the data request by passing on the data request to a data access router 211A, 211B, which will fulfill the request according to predefined factors identified in the data provider registry 213A. 213B. In particular, the data access engine 209A, 209B dynamically determines whether to source the data from a cloud operational data store, from data providers such as the cloud data center (DC), or the on-premise DC. As part of that determination, the data access engine 209A, 209B identifies whether to source to the default source (i.e., the cloud operational data store 215A, 215B) or from the cloud DC or the on-premise DC. This determination is made based on which source would the most efficient source to access the data, and then the data access engine 209A, 209B passes on the data request to the respective default source (i.e., the cloud operational data store 215A, 215B), cloud DC or on-premise DC via the data access router 211A, 211B. The data access router 211A, 211B connects to the most efficient source identified by the data access engine 209A, 209B to route the data request to that source. Once the data is retrieved, the data access engine 209A, 209B processes the data so that the data may be distributed in the proper format to the client device(s) 111A, 111B. Advantageously, by identifying a most efficient source from which to source the data, the hybrid cloud infrastructure environment 201 provides enhanced processing speed and reduced latencies.

The data provider registry 213A, 213B is the system of record with respect to all data sources and providers available via the hybrid-cloud environment 201. The data provider registry 213A, 213B includes metadata indicating the type of data, and the primary and secondary source of the data. In another implementation, the data provider registry 213A, 213B is also used to onboard the data via the administrative console 205A, 205B. The administrative console 205A, 205B includes the user interface that enables onboarding of data providers/sources and creates the data provider transform rules or predefined factors, which are stored to a combination of the data provider transform rules database 227A, 227B as well as the data provider registry 213A, 213B, that are used, in part, to determine whether the primary or secondary source will be accessed in order to retrieve the data. For these purposes, depending on the predefined factors, the primary or secondary source may include the public-cloud server(s) (i.e., the cloud DC), the private on-premise server(s) (i.e., the on-premise DC), and/or the cloud operational data store 215A, 215B. The data provider transform rules or predefined factors may be stored to the data provider transform rules database 227A, 227B in structured format and used by a data ingestion and transformation engine 223A, 223B to transform data according to the rules stored in the data provider transform rules database 227A, 227B. The administrative console 205A, 205B is also used by administrators to view ingestion logs, which are stored to an ingestion logs database 225A, 225B for data analysis. In particular, the ingestion logs database 225A, 225B provides a structured log of all data ingestion processed by the data ingestion and transformation engine 223A, 223B, including logs of successes and failures.

The data ingestion and transformation engine 223A, 223B is configured to pull data from the batch file landing zone 221A, 221B and streaming event queue 219A, 219B. Once the data has been retrieved from the batch file landing zone 221A, 221B and/or streaming event queue 219A. 219B, the data ingestion and transformation engine 223A, 223B transforms the data according to the rules in the data provider transform rules database 227A, 227B. The data ingestion and transformation engine 223A, 223B ingests data in-memory to decrypt, transform and re-encrypt the data according to need and loads the data into the cloud operational data store 215A, 215B. In particular, the process of extracting, transforming and loading the data (ETL process) is performed by the data ingestion and transformation engine 223A, 223B prior to storing the data to the cloud operational data store 215A, 215B.

For the majority of data, the cloud operational data store 215A, 215B serves as the primary data source for the system. If the data can be sourced from the cloud operational data store 215A, 215B via the data access router 211A, 211B, then this would be the default source for the request. However, if the data cannot be sourced from the cloud operational data store 215A, 215B then another cloud DC or an on-premise DC is used to source the data in accordance with the predefined factors. The cloud operational data store 215A, 215B is configured as an operational data store that works as a data proxy for onboarded data providers. Data stored to the cloud operational data store 215A, 215B is stored in the cloud (i.e., a distributed collection of servers) and facilitates fast, efficient and scalable access to data rather than sourcing the data directly from the data providers through the cloud DC or the on-premise DC. Alternatively, if the predefined factors indicate that the data is more efficiently sourced from the cloud DC or the on-premise DC, then the data access router 211A. 211B communicates with the cloud DC or the on-premise DC to access the data. Read only replicas 217A, 217B of the data stored to the cloud operational data store 215A, 215B are stored in one or more databases for analytics/reporting applications. The read only replicas 217A. 217B are routinely (e.g., concurrently, periodically, etc.) synced with the data stored to the cloud operational data store 215A, 215B.

The streaming event queue 219A, 219B is a secure data event queue that is configured to store change events from registered data providers to await ingestion from the data ingestion and transformation engine 223A, 223B. The events processed by the data ingestion and transformation engine 223A, 223B are processes as a stream according to the first-in, first-out (FIFO) method. The batch file landing zone 221A, 221B is configured as a secure data storage system to receive encrypted files from data providers prior to ingestion from the data ingestion and transformation engine 223A, 223B.

Referring now to FIG. 2B, when the data access router 211A, 211B communicates with the cloud DC or the on-premise DC to access data directly from the data provider, the data access router 211A, 211B interfaces with a respective existing data access API proxy, such as the existing data access API proxy 231 of the cloud DC or the existing data access API proxy 233 of the on-premise DC. The existing data access API proxy 231 of the cloud DC accesses data from one or more data providers (e.g., data provider one 235 that stores data to a first database 241, data provider two 237 that stores data to a second database 243, and/or data provider “n” 239 that stores data to “n” database 245). Real time change event(s), or near-real-time change event(s), are sourced from the various cloud DC data providers via a streaming event broker 247, which routes the change event(s) to the streaming event queue 219A, 219B of FIG. 2A. The streaming event broker 247 processes, encrypts, stores, and prior to routing the change event(s). Batch file data extracts are sourced from the various cloud DC data providers via a batch file transfer broker 249, which implements a managed file transfer to transfer batch files to the batch file landing zone 221A, 221B of FIG. 2A to await ingestion into the cloud operational data store 215A, 215B of FIG. 2A. The managed file transfer performed by the batch file transfer broker 249 includes data processing, encryption, storage and transfer.

Similarly, the data access router 211A, 211B communicates with the existing data access API proxy 233 of the on-premise DC, which provides the support logic that serves as the data access layer for various on-premise data providers (e.g., data provider one 251 that stores data to a first database 257, data provider two 253 that stores data to a second database 259, and/or data provider “n” 255 that stores data to “n” database 261). Real time change event(s), or near-real-time change event(s), are sourced from the various on-premise data providers via a streaming event broker 263, which routes the change event(s) to the streaming event queue 219A, 219B of FIG. 2A. The streaming event broker 263 processes, encrypts, stores, and prior to routing the change event(s). Batch file data extracts are sourced from the various on-premise data providers via a batch file transfer broker 265, which implements a managed file transfer to transfer batch files to the batch file landing zone 221A, 221B of FIG. 2A to await ingestion into the cloud operational data store 215A, 215B of FIG. 2A. The managed file transfer performed by the batch file transfer broker 265 includes data processing, encryption, storage and transfer.

FIG. 3 depicts a block diagram of an example method 300 for resilient data access facilitated by a hybrid-cloud infrastructure environment, in accordance with an embodiment of the present invention. At block 305, an API call is received from a client device (e.g., see client device(s) 111A, 111B), where the API call includes a request to access a portion of data. A data access engine (e.g., see data access engine 209A, 209B), in coordination with a data provider registry (e.g., see data provider registry 213A, 213B), dynamically determines, at block 310, a most efficient source from which to source the portion of the data, where the most efficient source is selected from the group consisting of (i) at least one public-cloud server (e.g., see cloud DC data providers of the cloud DC described above), (ii) at least one private on-premise server (e.g., see on-premise data providers of the on-premise DC described above), and (iii) a cloud operational data store (e.g., see cloud operational data store 215A, 215B). This determination includes analyzing one or more predefined factors and identifying a most efficient source to access the portion of the data. According to various embodiments, the one or more predefined factors are selected from the group consisting of data type, data state, and data availability. When the predefined factor influencing the determination includes the data type (e.g., static or dynamic data), the analysis includes analyzing the data type of the portion of the data. Example data types include the type of value a variable has that is used to determine programmatic routing logic. In some embodiments, the data type includes metadata selecting from the group consisting of applicability of personally identifiable information to the portion of the data, applicability of the Sarbanes-Oxley Act to the portion of the data, and the applicability of Health Insurance Portability and Accountability Act (HIPAA) to the portion of the data. When the predefined factor influencing the determination includes the data state, the data state may include, according to one embodiment, metadata including historical status of the portion of the data and/or pendency status of the portion of the data. According to various embodiments, when the predefined factor influencing the determination includes data availability, it takes into account reliability and timeliness for accessing the portion of the data including the underlying health of the applications that are functioning as the data providers (e.g., the cloud DC data providers, on-premise data providers described above). In some embodiments, the determination of block 310 is performed based on communication between a data access engine (e.g., see data access engine 209A, 209B) and a data provider registry (e.g., see data provider registry 213A, 213B).

At block 315, a data access router (e.g., see data access router 211A, 211B) transmits a request to the most efficient source to access the portion of the data. At block 320, the data access engine (e.g., see data access engine 209A, 209B) retrieves, via the data access router (e.g., see data access router 211A, 211B), the portion of the data from the most efficient source. At block 325, the API layer (e.g., see API layer 207A, 207B) exposes the data so that it can be accessed via the client device (e.g. see client device(s) 111A, 111B).

According to various embodiments, the hybrid-cloud infrastructure environment includes an external load balancer (e.g., see load balancer 203) configured to direct the API call to at least one instance of two instances of an API layer, where the two instances include a read only instance (e.g., such as the read only instance designated with “B” appended to the end of the number in FIG. 2A) and a read/write instance (e.g., such as the read/write instance designated with “A” appended to the end of the number in FIG. 2A). The instance to which the API call is directed is selected based on geographic proximity. Further, each respective instance (i.e., either the read only instance or the read/write instance) of the API layer facilitate the API call by communicating the API call to a respective data access router (e.g., see data access router 211A, 211B) by way of a respective data access engine (e.g., see data access engine 209A, 209B) and a respective data provider registry (e.g., see data provider registry 213A, 213B).

In some embodiments, the default source of the data is the cloud operational data store (e.g., see cloud operational data store 215A, 215B), which is configured to coordinate with a data ingestion and transformation engine (e.g., see data ingestion and transformation engine 223A, 223B) to extract, transform, and load the data. In particular the data ingestion and transformation engine (e.g., see data ingestion and transformation engine 223A, 223B) facilitates both batch file loading of encrypted files from data providers (e.g., see cloud DC data providers of the cloud DC described above), where the data providers include (i) at least one public-cloud server and (ii) at least one private on-premise server. In some embodiments, the method 300 also includes redundantly storing data to the cloud operational data store (e.g., see cloud operational data store 215A, 215B) from (i) at least one public-cloud server and (ii) at least one private on-premise server. This redundant storing includes periodically performing batch file transfers from encrypted files and periodically storing change events.

FIG. 4 depicts a block diagram of an example method 400 for resilient data access, in accordance with an embodiment of the present invention. At block 405, data is redundantly stored to a cloud operational data store (e.g., see cloud operational data store 215A, 215B) of a hybrid cloud infrastructure environment from (i) at least one public-cloud server (e.g., see cloud DC data providers of the cloud DC described above) and (ii) at least one private on-premise server (e.g., see on-premise DC data providers of the on-premise DC described above). According to one embodiment, a default source of the data is the cloud operational data store (e.g., see cloud operational data store 215A, 215B), where the cloud operational data store is configured to coordinate with a data ingestion and transformation engine (e.g., see data ingestion and transformation engine 223A, 223B) to extract, transform, and load the data to the cloud operational data store (e.g., see cloud operational data store 215A, 215B) as part of the storing of the data.

At block 410, an API call is received, via a client device, to access a portion of the data. At block 415, a most efficient source from which to source the data is dynamically determined from the group consisting of (i) the at least one public-cloud server (e.g., see cloud DC data providers of the cloud DC described above), (ii) the at least one private on-premise server (e.g., see on-premise DC data providers of the on-premise DC described above), and (iii) the cloud operational data store (e.g., see cloud operational data store 215A, 215B). Further, this dynamic determination includes analyzing one or more predefined factors and identifying a most efficient source to access the portion of the data. According to one embodiment, the one or more predefined factors are selected from the group consisting of data type, data state, and data availability. The dynamic determination includes analyzing the data type, analyzing the data state, and/or analyzing data availability of the portion of the data requested via the API call.

At block 420, a request is transmitted to the most efficient source to access the portion of the data. At block 425, the portion of the data is retrieved from the most efficient source and at block 430 the portion of the data is exposed for access via the client device. According to one embodiment, the computing system includes an external load balancer (e.g., see load balancer 203) configured to direct the API call to at least one instance of two instances of an API layer, where the two instances include a read only instance and a read/write instance. According to one embodiment, the at least one instance is selected based on geographic proximity. Further, each instance of the two instances of the API layer facilitate the API call by communicating the API call to a respective data access router (e.g., see data access router 211A, 211B) by way of a respective data access engine (e.g., see data access engine 209A, 209B) and a respective data provider registry (e.g., see data provider registry 213A, 213B).

FIG. 5 depicts a block diagram of an example method 500 for application programming interface (API) call routing, in accordance with an embodiment of the present invention. At block 505, a replica of data is transferred from at least one data provider, where the at least one data provider includes either (I) at least one public-cloud resource, or (II) at least one private on-premise resource. The transferring includes (A) extracting data from the at least one data provider to a temporary location, (B) transforming the extracted data into a format suitable for loading the data to a cloud operational data store, and (C) loading the transformed data to the cloud operational data store. According to one embodiment, the replica of the data is received from the at least one data provider via a data receiving process at a batch file transfer broker to facilitate the extracting to the temporary location. Further, the batch file transfer broker may be configured to receive batch file extracts from the at least one data provider to facilitate the extracting of the batch file extracts. According to another embodiment, the replica of the data is received from the at least one data provider via a streaming event queue to facilitate the extracting to the temporary location. The streaming event queue may be configured to receive encrypted files from the data providers and securely store the encrypted files to facilitate extracting the encrypted files to the temporary location. According to various embodiments, the temporary location includes a data ingestion and transformation engine, where the data ingestion and transformation performs the transforming of the extracted data using a plurality of rules stored to a data provider transform rules database, where the transforming includes data decryption, data transformation, and data re-encryption of the extracted data. In some embodiments, the method 500 further includes creating a structured log of all the transformed data.

At block 510, one or more data enrichment processes are performed to the replica of the data loaded to the cloud operational data store. These enrichment processes can include incorporating new updates and information in order to improve accuracy and reliability. Specifically, data enrichment may integrate transaction data from multiple data sources and formats the data so that it can be displayed to the customer in a way that would improve clarity, would generate insights, and would enable the customer to take various actions related to particular transactions. At block 515, data access is provided within a hybrid-cloud infrastructure environment by routing an API call to access a portion of data from a location selected from the group consisting of (I) the at least one public-cloud resource, (II) the at least one on-premise resource, and (III) the replica of the data loaded to the cloud operational data store. According to various embodiments, the hybrid-cloud infrastructure environment includes a multi-region environment that includes read replica databases at a plurality of geographic locations, where the read replica databases facilitate deployment of respective read-only database instances to the plurality of geographic locations. According to various embodiments, the hybrid-cloud infrastructure environment includes a primary database instance that includes a read/write instance.

Computer program instructions are configured to carry out operations of the present invention and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to explain the principles of one or more aspects of the invention and the practical application thereof, and to enable others of ordinary skill in the art to understand one or more aspects of the invention for various embodiments with various modifications as are suited to the particular use contemplated.

It is to be noted that various terms used herein such as “Linux®,” “Windows®,” “macOS®,” “iOS®,” “Android®,” and the like may be subject to trademark rights in various jurisdictions throughout the world and are used here only in reference to the products or services properly denominated by the marks to the extent that such trademark rights may exist.

What is claimed is:

1. A hybrid-cloud infrastructure environment for application programming interface (API) call routing, the hybrid-cloud infrastructure environment comprising:
at least one public-cloud resource;
at least one private on-premise resource; and
a computing system comprising:
at least one processor;
a communication interface communicatively coupled to the at least one processor; and
a memory device storing executable code that, when executed, causes the at least one processor to:
transfer a replica of data from at least one data provider, the at least one data provider including either the at least one public-cloud resource or the at least one private on-premise resource, the transferring comprising:
extracting data from the at least one data provider to a temporary location;
transforming the extracted data into a format suitable for loading the data to a cloud operational data store; and
loading the transformed data to the cloud operational data store;
perform one or more data enrichment processes to the replica of the data loaded to the cloud operational data store; and
provide, within the hybrid-cloud infrastructure environment, data access by routing an API call to access the data from a location selected from the group consisting of (i) the at least one public-cloud resource, (ii) the at least one on-premise resource, and (iii) the replica of the data loaded to the cloud operational data store.

2. The hybrid cloud infrastructure environment of claim 1, wherein the hybrid-cloud infrastructure environment comprises a multi-region environment comprising read replica databases at a plurality of geographic locations, the read replica databases facilitating deployment of respective read-only database instances to the plurality of geographic locations.

3. The hybrid cloud infrastructure environment of claim 1, wherein the hybrid-cloud infrastructure environment comprises a primary database instance comprising a read/write instance.

4. The hybrid cloud infrastructure environment of claim 1, wherein the replica of the data from the at least one data provider is received via a data receiving process at a batch file transfer broker to facilitate the extracting to the temporary location.

5. The hybrid cloud infrastructure environment of claim 4, wherein the batch file transfer broker is configured to receive batch file extracts from the at least one data provider to facilitate the extracting of the batch file extracts.

6. The hybrid cloud infrastructure environment of claim 1, wherein the replica of the data from the at least one data provider is received via a streaming event queue to facilitate the extracting to the temporary location.

7. The hybrid cloud infrastructure environment of claim 6, wherein the streaming event queue is configured to receive encrypted files from the data providers and securely store the encrypted files to facilitate extracting the encrypted files to the temporary location.

8. The hybrid cloud infrastructure environment of claim 1, wherein the temporary location comprises a data ingestion and transformation engine, wherein the data ingestion and transformation engine performs the transforming of the extracted data using a plurality of rules stored to a data provider transform rules database, wherein the transforming comprises data decryption, data transformation, and data re-encryption of the extracted data.

9. The hybrid cloud infrastructure environment of claim 1, wherein the executable code further causes the at least one processor to create a structured log of all the transformed data.

10. A computing system for data process management, the computing system comprising:
at least one processor;
a communication interface communicatively coupled to the at least one processor; and
a memory device storing executable code that, when executed, causes the at least one processor to:
transfer a replica of data from at least one data provider, the at least one data provider including either (i) at least one public-cloud resource or (ii) at least one private on-premise resource, the transferring comprising:
extracting data from the at least one data provider to a temporary location;
transforming the extracted data into a format suitable for loading the data to a cloud operational data store; and
loading the transformed data to the cloud operational data store;
perform one or more data enrichment processes to the replica of the data loaded to the cloud operational data store; and
provide, within a hybrid-cloud infrastructure environment, data access by routing an API call to access the data from a location selected from the group consisting of (i) the at least one public-cloud resource, (ii) the at least one on-premise resource, and (iii) the replica of the data loaded to the cloud operational data store.

11. The computing system of claim 10, wherein the hybrid-cloud infrastructure environment comprises a multi-region environment comprising read replica databases at a plurality of geographic locations, the read replica databases facilitating deployment of respective read-only database instances to the plurality of geographic locations.

12. The computing system of claim 10, wherein the hybrid-cloud infrastructure environment comprises a primary database instance comprising a read/write instance.

13. The computing system of claim 10, wherein the nearest read replica database is determined based on geographic location of the read replica databases at the plurality of locations.

14. The computing system of claim 10, wherein the replica of the data from the at least one data provider is received via a data receiving process at a batch file transfer broker to facilitate the extracting to the temporary location.

15. The computing system of claim 14, wherein the batch file transfer broker is configured to receive batch file extracts from the at least one data provider to facilitate the extracting of the batch file extracts.

16. The computing system of claim 10, wherein the replica of the data from the at least one data provider is received via a streaming event queue to facilitate the extracting to the temporary location.

17. The computing system of claim 16, wherein the streaming event queue is configured to receive encrypted files from the data providers and securely store the encrypted files to facilitate extracting the encrypted files to the temporary location.

18. A computer-implemented method for data process management, the computer-implemented method comprising:
transferring a replica of data from at least one data provider, the at least one data provider including either (i) at least one public-cloud resource or (ii) at least one private on-premise resource, the transferring comprising:
extracting data from the at least one data provider to a temporary location;
transforming the extracted data into a format suitable for loading the data to a cloud operational data store; and
loading the transformed data to the cloud operational data store;
performing one or more data enrichment processes to the replica of the data loaded to the cloud operational data store; and
providing, within a hybrid-cloud infrastructure environment, data access by routing an API call to access the data from a location selected from the group consisting of (i) the at least one public-cloud resource, (ii) the at least one on-premise resource, and (iii) the replica of the data loaded to the cloud operational data store.

19. The computer-implemented method of claim 18, wherein the hybrid-cloud infrastructure environment comprises a multi-region environment comprising read replica databases at a plurality of geographic locations, the read replica databases facilitating deployment of respective read-only database instances to the plurality of geographic locations.

20. The computer-implemented method of claim 19, wherein the hybrid-cloud infrastructure environment comprises a primary database instance comprising a read/write instance.
